(19) United States
(12) Patent Application Publication
(10) Pub. No.: US 2025/0102956 A1
(43) Pub. Date: Mar. 27, 2025

(54) DEVELOPING APPARATUS AND IMAGE FORMING APPARATUS

(71) Applicant: FUJIFILM Business Innovation Corp., Tokyo (JP)

(72) Inventors: Shigemi MURATA, Kanagawa (JP); Kenta URAYAMA, Kanagawa (JP); Tomoyuki YOSHII, Kanagawa (JP)

(73) Assignee: FUJIFILM Business Innovation Corp., Tokyo (JP)

(21) Appl. No.: 18/585,021

(22) Filed: Feb. 22, 2024

(30) Foreign Application Priority Data
Sep. 26, 2023 (JP) 2023-163850

(51) Int. Cl. G03G 15/08

(52) U.S. Cl. CPC G03G 15/0891; G03G 15/0889; G03G 2215/083

(57) ABSTRACT

A developing apparatus includes a developer holder that holds a developer; an accommodation portion that accommodates the developer to be supplied to the developer holder; a rotation shaft rotatably provided inside the accommodation portion; a first conveyance portion that is provided on the rotation shaft and conveys the developer in a direction intersecting an axial direction of the rotation shaft; a second conveyance portion that is provided on the rotation shaft and conveys the developer in the axial direction; a discharge port that is provided in the accommodation portion and through which a part of the developer is discharged to an outside at a position corresponding to a position where the first conveyance portion is provided in the axial direction; and a pressure adjustment port that is provided in the accommodation portion and through which a pressure of the accommodation portion is adjusted at a position in a rotation direction of the first conveyance portion with respect to the discharge port, the position corresponding to a position where the first conveyance portion is provided in the axial direction.

### CROSS-REFERENCE TO RELATED APPLICATIONS

This application is based on and claims priority under 35 USC 119 from Japanese Patent Application No. 2023-163850 filed Sep. 26, 2023.

### BACKGROUND

### (i) Technical Field

The present invention relates to a developing apparatus and an image forming apparatus.

### (ii) Related Art

JP2021-96400A discloses a developing machine that includes a discharge portion that is arranged on the downstream side of an agitating chamber in a first direction and arranged on the downstream side of a return blade in the first direction, and discharges a part of a developer from a developing apparatus; a first route that allows communication between a portion above the return blade in the agitating chamber and the discharge portion to discharge the developer to the discharge portion; and a second route that is separated from the first route by a partition wall, and allows communication between a portion above an agent surface of the developer accommodated in the agitating chamber, in the agitating chamber and the discharge portion to allow air to circulate from the agitating chamber to the discharge portion.

JP2012-234153A discloses that a developer in a developing chamber is conveyed in one direction with a rotation of a first conveyance screw, a part of the circulating developer overflows to be discharged from a developer discharge port in a case where toner and carrier are replenished from a hopper to the developing chamber, the first conveyance screw has a spiral blade formed excluding a region along the developer discharge port of the developing chamber, and a rib is regionally formed on the region to agitate or vibrate the developer in the region along the developer discharge port with the rotation of the first conveyance screw.

### SUMMARY

In an image forming apparatus using an electrophotographic method or the like, an electrostatic latent image formed on an image holder is developed as a toner image by a developing apparatus. In such a developing apparatus, in order to suppress deterioration of the developer, a so-called trickle mechanism that discharges the excess developer from a discharge port and replenishes a new developer to gradually replace the developer. In a case where a trickle mechanism is adopted and the developer is discharged from the discharge port, in a case where a change in pressure occurs at the discharge port, the amount of the developer discharged fluctuates.

Aspects of non-limiting embodiments of the present disclosure relate to a developing apparatus and an image forming apparatus that suppress fluctuations in the amount of the developer discharged.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing apparatus includes a developer holder that holds a developer; an accommodation portion that accommodates the developer to be supplied to the developer holder; a rotation shaft rotatably provided inside the accommodation portion; a first conveyance portion that is provided on the rotation shaft and conveys the developer in a direction intersecting an axial direction of the rotation shaft; a second conveyance portion that is provided on the rotation shaft and conveys the developer in the axial direction; a discharge port that is provided in the accommodation portion and through which a part of the developer is discharged to an outside at a position corresponding to a position where the first conveyance portion is provided in the axial direction; and a pressure adjustment port that is provided in the accommodation portion and through which a pressure of the accommodation portion is adjusted at a position in a rotation direction of the first conveyance portion with respect to the discharge port, the position corresponding to a position where the first conveyance portion is provided in the axial direction.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIG. 2 is a diagram illustrating a developing device;

FIG. 3 is a diagram for describing an inside of an accommodation portion, and illustrates an internal structure of the accommodation portion from above in an up-down direction of FIG. 2;

FIG. 4 is a perspective view illustrating an end portion side on a front side of the accommodation portion extending in an axial direction;

FIG. 5 is a diagram illustrating a state in which a closing portion is removed in the perspective view of FIG. 4;

FIG. 6 is a diagram illustrating details of the closing portion illustrated in FIG. 4;

FIG. 7 is a schematic diagram of an inside of an agitation path viewed from VII direction in FIG. 4, and is a diagram describing a positional relationship among a discharge paddle, a discharge port, and a pressure adjustment port in the axial direction; and

FIG. 8 is a diagram illustrating a part of VIII-VIII cross section in FIG. 3, and is a diagram describing a positional relationship among the discharge paddle, the discharge port, and the pressure adjustment port in a direction intersecting the axial direction.

### DETAILED DESCRIPTION

Hereinafter, exemplary embodiments of the present invention will be described in detail with reference to the accompanying drawings.

### Description of Image Forming Apparatus

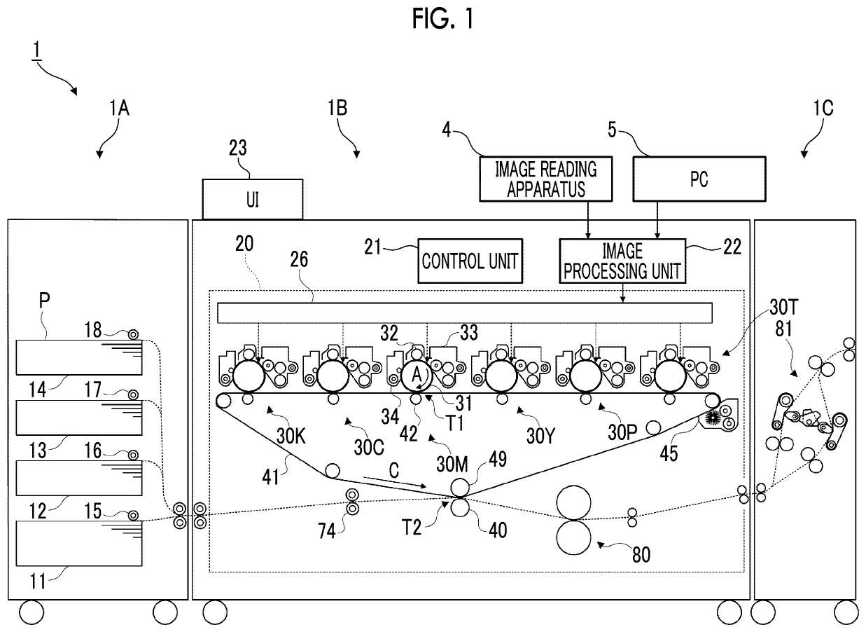

FIG. 1 is a diagram illustrating an image forming apparatus 1.

The image forming apparatus 1 according to the present exemplary embodiment includes a paper feeding unit 1A, a printing unit 1B, and a paper discharge unit 1C.

The paper feeding unit 1A includes a first paper accommodation portion 11 to a fourth paper accommodation portion 14 that accommodate paper P as an example of a recording medium.

In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1.

In addition, the printing unit 1B also includes an image processing unit 22. The image processing unit 22 performs image processing on image data transmitted from an image reading apparatus 4 and a personal computer (PC) 5.

In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals.

Each image forming unit 30 includes a photosensitive drum 31 on which an electrostatic latent image is formed while rotating in a direction of arrow A, a charging roll 32 that charges a surface of the photosensitive drum 31, a developing device 33 as a developing apparatus that develops the electrostatic latent image formed on the photosensitive drum 31, and a drum cleaner 34 that removes toner or the like on the surface of the photosensitive drum 31.

In addition, the image forming portion 20 is provided with an exposure device 26 that exposes each photosensitive drum 31 of each image forming unit 30 with laser light.

Note that the exposure of the photosensitive drum 31 by the exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner housed in the developing device 33. The image forming units 30Y, 30M, 30C, and 30K form yellow (Y), magenta (M), cyan (C), and black (K) toner images, respectively.

In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred.

In addition, the image forming portion 20 is provided with a primary transfer roll 42 that transfers each color toner image of each image forming unit 30 onto the intermediate transfer belt 41 at a primary transfer portion T1.

In addition, the image forming portion 20 is provided with a secondary transfer roll 40 that transfers the toner images transferred onto the intermediate transfer belt 41 all at once onto the paper P at a secondary transfer portion T2.

Further, the image forming portion 20 is provided with a belt cleaner 45 that removes toner or the like on the surface of the intermediate transfer belt 41, and a fixing device 80 that fixes the secondarily transferred image onto the paper P.

The image forming portion 20 performs an image forming operation on the basis of a control signal from the control unit 21.

Specifically, in the image forming portion 20, first, image processing is performed by the image processing unit 22 on the image data input from the image reading apparatus 4 or the PC 5, and the image data after the image processing is performed is supplied to the exposure device 26.

Then, for example, in the image forming unit 30M for magenta (M), after the surface of the photosensitive drum 31 is charged by the charging roll 32, the photosensitive drum 31 is irradiated by the exposure device 26 with the laser light modulated with the image data obtained from the image processing unit 22.

In this manner, the electrostatic latent image is formed on the photosensitive drum 31.

The formed electrostatic latent image is developed by the developing device 33, and a magenta toner image is formed on the photosensitive drum 31.

Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41.

The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route.

In a case where the superimposed toner images are conveyed to the secondary transfer portion T2, the paper P is supplied from the registration roll 74 to the secondary transfer portion T2 at the same time.

Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80.

In the fixing device 80, the paper P on which the unfixed toner image is formed is pressurized and heated, and fixing processing of the toner image on the paper P is performed.

Then, the paper P on which the fixing processing has been performed is conveyed to a paper stacking portion (not illustrated) after passing through a curl correction portion 81 provided in the paper discharge unit 1C.

### Description of Developing Apparatus

Next, the developing device 33 as the developing apparatus will be described. Note that the developing devices 33 for respective colors have the identical structure, one developing device 33 will be described as an example.

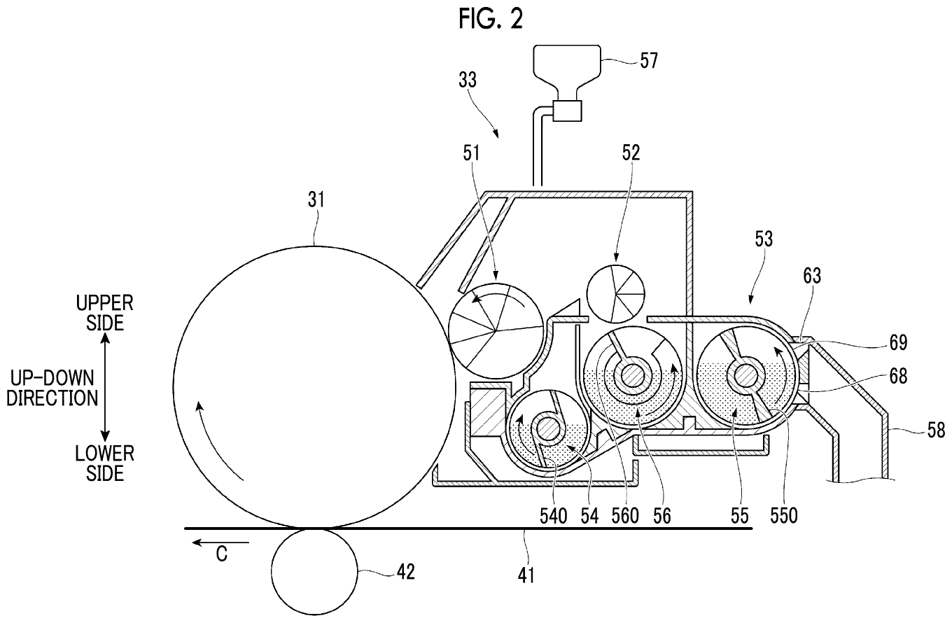

FIG. 2 is a diagram illustrating the developing device 33.

The developing device 33 includes a developing roll 51 that develops the electrostatic latent image on the photosensitive drum 31, a pumping roll 52 that supplies the developer to the developing roll 51, and an accommodation portion 53 that accommodates the developer to be pumped by the pumping roll 52. In addition, the developing device 33 includes a toner bottle 57 that supplies toner to the accommodation portion 53, and a discharge route 58 that is a route for discarding the developer discharged from the accommodation portion 53. The developing roll 51 functions as a developer holder that holds the developer.

The developing roll 51 rotates while holding the developer, and develops the electrostatic latent image on the photosensitive drum 31. The pumping roll 52 is positioned above a supply path 56, which will be described later, in an up-down direction. Here, the up-down direction refers to the gravity direction as a downward direction, and a direction opposite to the gravity direction as an upward direction. The pumping roll 52 pumps up the developer in the supply path 56 arranged along the pumping roll 52, and replenishes the developing roll 51 with the developer.

The accommodation portion 53 accommodates the developer and conveys the developer while agitating the developer. The accommodation portion 53 includes a replenishment path 54, an agitation path 55, and the supply path 56 as routes for conveying the developer. In FIG. 2, the replenishment path 54, the agitation path 55, and the supply path 56 are conduits that extend in an axial direction of the developing roll 51 in a direction orthogonal to the paper plane and extend toward the front side and the back side of the apparatus. The replenishment path 54 includes a replenishment auger 540 that conveys the developer in the replenishment path 54. The agitation path 55 includes an agitation auger 550 that conveys the developer in the agitation path 55, and includes a discharge port 68 for discharging a part of the developer to the outside, and a pressure adjustment port 69 through which the pressure in the agitation path 55 is adjusted. The discharge port 68 and the pressure adjustment port 69 are openings opened on the side surface of the agitation path 55, and a lower end of the opening of the pressure adjustment port 69 is provided above an upper end of the opening of the discharge port 68. A connection portion 63 for connecting to the discharge route 58 protrudes in the horizontal direction from the outer peripheral side of the conduit of the agitation path 55. The supply path 56 includes a supply auger 560 that conveys the developer in the supply path 56.

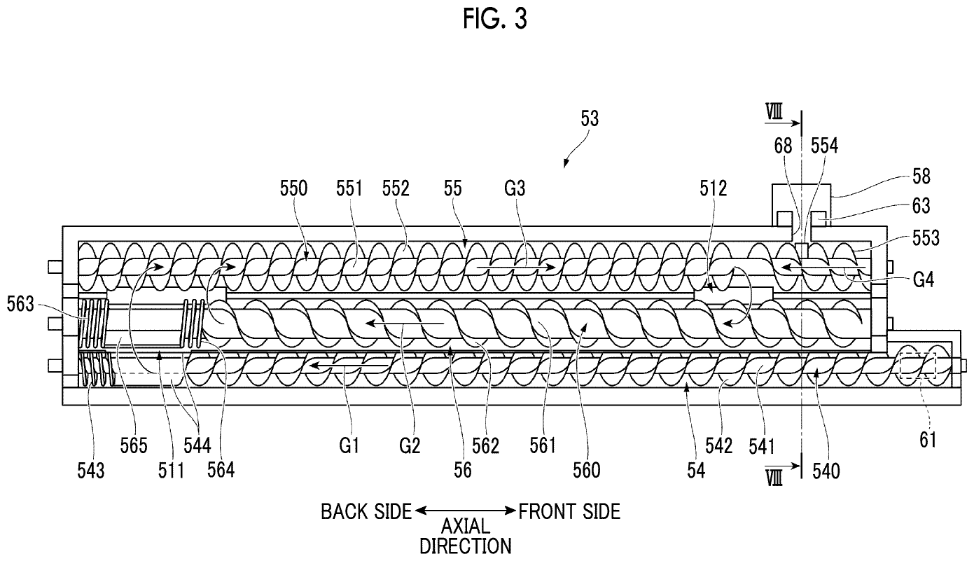

The toner bottle 57 is connected to a developer replenishment port 61 (refer to FIG. 3) provided on the front side of the replenishment path 54 in the paper plane, and replenishes the replenishment path 54 with new toner in the toner bottle 57.

The discharge route 58 is configured to cover both openings of the discharge port 68 and the pressure adjustment port 69 so that the developer discharged from the discharge port 68 does not leak into the image forming apparatus 1. The discharge route 58 is connected to a collection bottle for collecting used developer, and the discharged developer is collected. The discharge route 58 is fixed to the connection portion 63 by, for example, a bolt.

FIG. 3 is a diagram for describing the inside of the accommodation portion 53, and illustrates an internal structure of the accommodation portion 53 from above in the up-down direction of FIG. 2. In FIG. 3, the left side is the back side, and the right side is the front side, and the replenishment auger 540, the agitation auger 550, and the supply auger 560 extend in the axial direction.

The replenishment path 54 and the agitation path 55 are connected by a first communication path 511 that crosses the supply path 56 on the back side of the apparatus, and the developer is conveyed. In addition, the agitation path 55 and the supply path 56 are connected by a second communication path 512 on the front side of the apparatus, and the developer is conveyed.

### Replenishment Path 54

The replenishment path 54, which is a part of the accommodation portion 53, includes the developer replenishment port 61 that is an opening for replenishing new developer. The developer replenishment port 61 is connected to the toner bottle 57 (refer to FIG. 2). The replenishment auger 540 includes a rotation shaft 541 rotatably attached in the replenishment path 54. The rotation shaft 541 is rotatably provided from the front side to the back side of the replenishment path 54. The rotation shaft 541 of the replenishment auger 540 is provided with a spiral blade 542 for conveying the developer, a reverse spiral blade 543, and a push-up paddle 544.

The spiral blade 542 conveys the developer from the front side to the back side in the axial direction along with the rotation of the rotation shaft 541. The conveyance direction is indicated as a G1 direction in FIG. 3. The reverse spiral blade 543 pushes back the developer, which has been conveyed to the end portion of the replenishment path 54 on the back side, toward the front side. The push-up paddle 544 is provided in the replenishment path 54 to be at a position corresponding to the first communication path 511, and conveys the developer to the supply path 56 via the first communication path 511.

### Agitation Path 55

As described above, the agitation path 55, which is a part of the accommodation portion 53, includes the discharge port 68, the pressure adjustment port 69 (refer to FIG. 2), and the agitation auger 550 for conveying the developer in the agitation path 55.

The agitation auger 550 includes a rotation shaft 551 rotatably provided from the front side to the back side in the agitation path 55. The agitation auger 550 includes a spiral blade 552 for conveying the developer, a reverse spiral blade 553, and a discharge paddle 554. The spiral blade 552, the reverse spiral blade 553, and the discharge paddle 554 are provided on the rotation shaft 551.

The spiral blade 552 is an example of an agitation conveyance portion, and the reverse spiral blade 553 is an example of a turning-back portion. In addition, the spiral blade 552 and the reverse spiral blade 553 are an example of a second conveyance portion. In addition, the discharge paddle 554 is an example of a first conveyance portion.

The spiral blade 552 conveys the developer from the back side to the front side in the axial direction along with the rotation of the rotation shaft 551. The conveyance direction is indicated as a G3 direction in FIG. 3.

The reverse spiral blade 553 is provided on the front side of the rotation shaft 551. The reverse spiral blade 553 conveys the developer from the front side to the back side in the axial direction along with the rotation of the rotation shaft 551. The conveyance direction is indicated as a G4 direction in FIG. 3. In other words, the reverse spiral blade 553 conveys the developer, which has been conveyed in one direction by the spiral blade 552 while the developer is agitated, in a direction opposite to the one direction.

The discharge paddle 554 is provided at a position where the reverse spiral blade 553 is arranged in the axial direction, and is provided between the blades of the reverse spiral blade 553. The discharge paddle 554 conveys the developer toward the discharge port 68 along with the rotation of the rotation shaft 551. In other words, the discharge paddle 554 conveys the developer in a direction intersecting the axial direction of the rotation shaft 551.

### Supply Path 56

The supply auger 560 of the supply path 56 as a part of the accommodation portion 53 includes a rotation shaft 561 that is rotatably attached within the supply path 56. The supply auger 560 is provided on the rotation shaft 561, and includes a spiral blade 562 for conveying the developer, a reverse spiral blade 563, a damming spiral blade 564, and a delivery plate 565. The spiral blade 562, the reverse spiral blade 563, the damming spiral blade 564, and the delivery plate 565 are provided on the rotation shaft 561.

The spiral blade 562 conveys the developer from the front side to the back side in the axial direction along with the rotation of the rotation shaft 561. The conveyance direction is indicated as a G2 direction in FIG. 3. The reverse spiral blade 563 pushes back the developer, which has been conveyed to the end portion of the supply path 56 on the back side, toward the front side along with the rotation of the rotation shaft 561. The damming spiral blade 564 dams the developer conveyed from the front side to the back side by the spiral blade 562 along with the rotation of the rotation shaft 561, and urges the developer to flow into the agitation path 55.

The delivery plate 565 is provided at a position corresponding to the first communication path 511, and conveys the developer to the agitation path 55 along with the rotation of the rotation shaft 561.

### Description of Discharge Port 68 and Pressure Adjustment Port 69

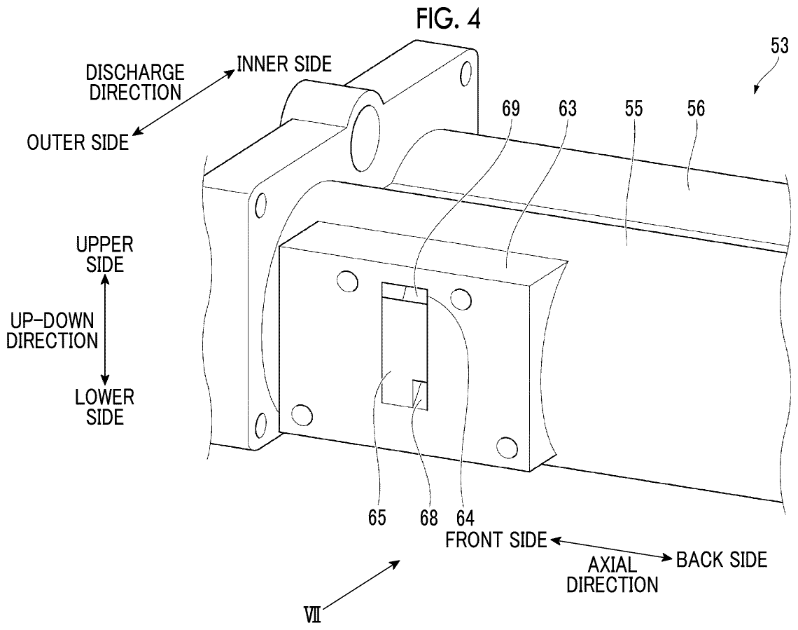

Next, the discharge port 68 and the pressure adjustment port 69 to which the present exemplary embodiment is applied will be described using FIGS. 4 to 6.

FIG. 4 is a perspective view illustrating an end portion side on the front side of the accommodation portion 53 extending in the axial direction. Here, a through-hole 64 and a closing portion 65 of the connection portion 63 are illustrated.

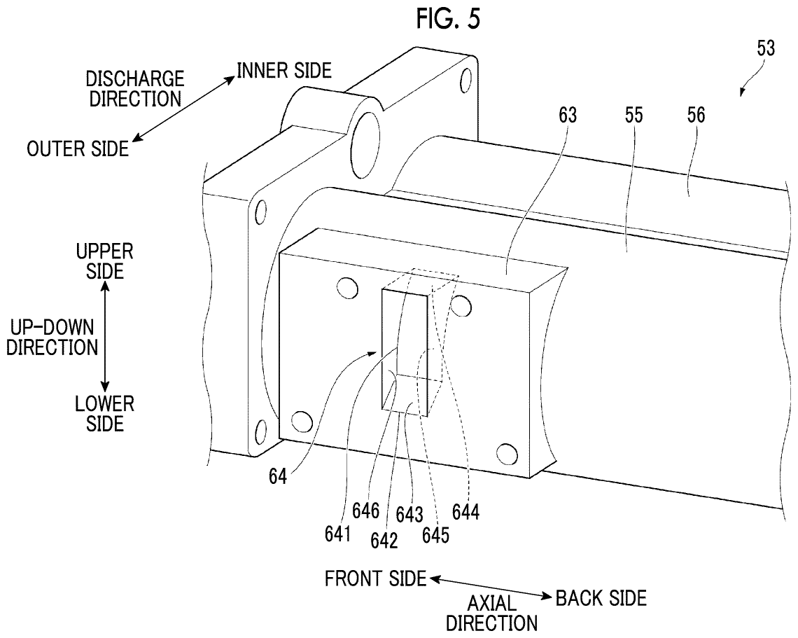

FIG. 5 is a diagram illustrating a state in which the closing portion 65 is removed in the perspective view of FIG. 4.

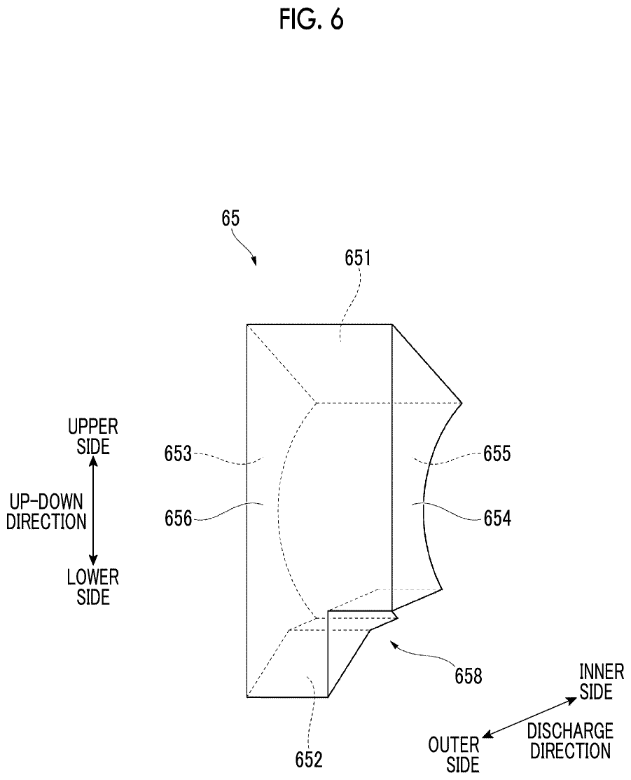

FIG. 6 is a diagram illustrating details of the closing portion 65 illustrated in FIG. 4.

As illustrated in FIG. 4, the connection portion 63 for connecting to the discharge route 58 (refer to FIG. 2) is provided on the front side of the agitation path 55 in the axial direction. The connection portion 63 is provided to protrude from the outer surface of the agitation path 55, and has a thickness extending from the outer surface of the agitation path 55 toward the outer side in a discharge direction. The connection portion 63 includes the through-hole 64 that connects the agitation path 55 and the discharge route 58. In addition, the connection portion 63 includes the closing portion 65 that partially closes the through-hole 64. The through-hole 64 and the closing portion 65 form the discharge port 68 and the pressure adjustment port 69.

As illustrated in FIG. 5, the through-hole 64 includes an internal opening 641 that is an opening on the agitation path 55 side, and an external opening 642 that is an opening on the discharge route 58 side. The internal opening 641 is an example of a common opening that is one opening provided in the agitation path 55 that constitutes a part of the accommodation portion 53. The shapes of the internal opening 641 and the external opening 642 are rectangular shapes in a case of being viewed from the outer side to the inner side in the discharge direction in FIG. 5.

The through-hole 64 has, for example, four inner surfaces. A lower inner surface 643, which is the inner surface on the lower side among the four inner surfaces, is formed with a slope that extends downward toward the outside so that the through-hole 64 widens from the inner portion toward the outer portion of the agitation path 55. An upper inner surface 644, which is the inner surface on the upper side among the four inner surfaces, is a surface parallel to the horizontal plane. A first side inner surface 645 on the back side in the axial direction and a second side inner surface 646 on the front side in the axial direction are arranged to face each other.

Next, the closing portion 65 (refer to FIG. 4) is formed to partially close the inside of the through-hole 64. This closing portion 65 is provided to be replaceable. Then, the closing portion 65 allows the discharge port 68 and the pressure adjustment port 69 provided in the connection portion 63 to have different positions or shapes, or different positions and shapes depending on the characteristics of the developer accommodated in the accommodation portion 53.

In the example illustrated in FIG. 6, the closing portion 65 has a lower surface 652 provided along the slope of the lower inner surface 643 of the through-hole 64. In addition, the width of the closing portion 65 is made to be approximately the same as the width of the through-hole 64. The height of the closing portion 65 is shorter than the height of the external opening 642 of the through-hole 64, and in a case where the lower surface 652 is brought into contact with the lower inner surface 643, a gap is formed at the upper portion of the through-hole 64 as illustrated in FIG. 4. This gap is the pressure adjustment port 69. Due to this gap, the air inside the agitation path 55 is discharged to the outside of the agitation path 55, and the pressure inside the agitation path 55 is adjusted.

In addition, an upper surface 651, which is a surface on the upper side of the closing portion 65, is a slope that extends upward from the inside of the agitation path 55 toward the outside in a case where the upper surface 651 is arranged in the through-hole 64. For example, the developer may be splashed up by the discharge paddle 554 (refer to FIG. 3), and the developer may pass through the pressure adjustment port 69 to be positioned on the upper surface 651. In this case, the developer placed on the upper surface 651 falls along the slope to be moved toward the agitation path 55 that is a part of the accommodation portion 53. In addition, the closing portion 65 includes a recess portion 658 obtained such that the lower right part of the closing portion 65 is recessed, in FIG. 6. In a case where the closing portion 65 is fitted into the through-hole 64, the gap formed between the recess portion 658 and the through-hole 64 is the discharge port 68 for discharging the developer.

Regarding Positional Relationship among Discharge Port, Pressure Adjustment Port, and Discharge Paddle

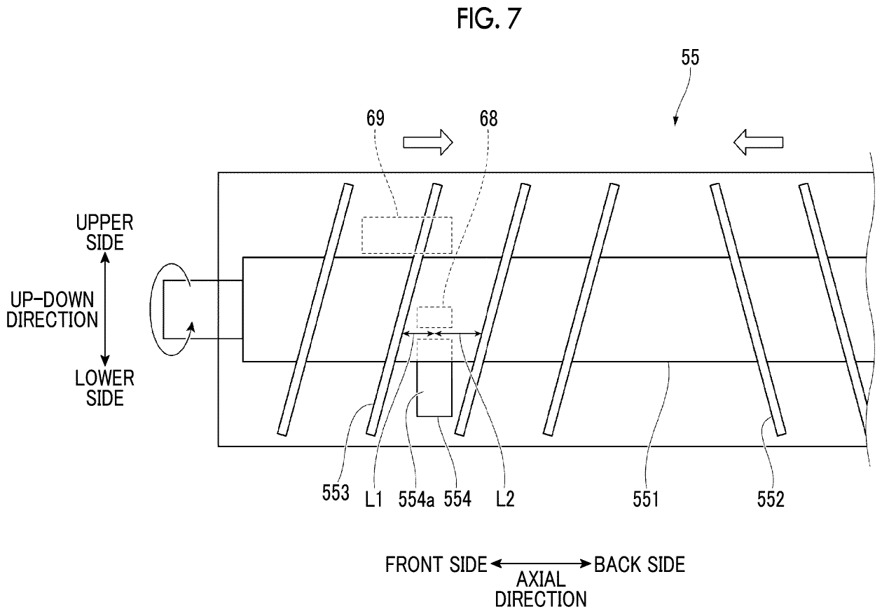

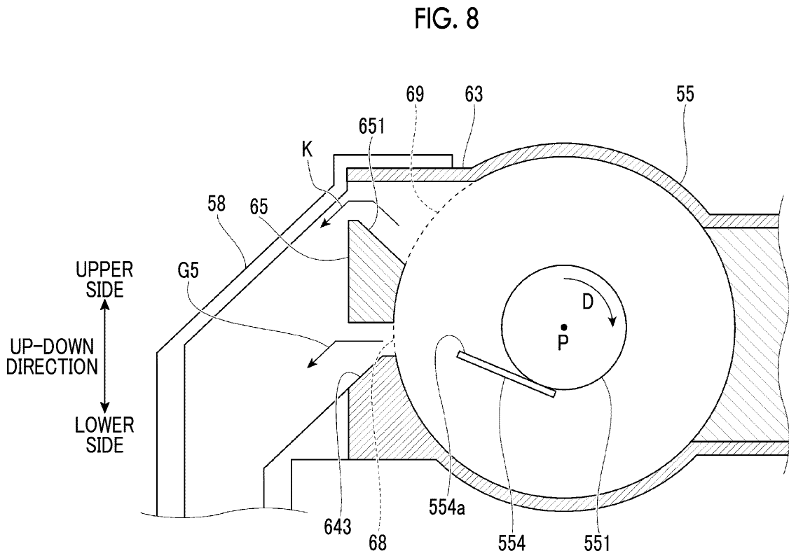

Next, the positional relationship among the discharge paddle 554, the discharge port 68, and the pressure adjustment port 69 will be described using FIGS. 7 and 8. FIG. 7 is a schematic diagram of the inside of the agitation path 55 viewed from VII direction in FIG. 4, and is a diagram describing the positional relationship among the discharge paddle 554, the discharge port 68, and the pressure adjustment port 69 in the axial direction. In addition, FIG. 8 is a diagram illustrating a part of VIII-VIII cross section in FIG. 3, and is a diagram describing the positional relationship among the discharge paddle 554, the discharge port 68, and the pressure adjustment port 69 in a direction intersecting the axial direction.

As illustrated in FIGS. 7 and 8, the discharge paddle 554 is a plate-shaped member provided on the rotation shaft 551, and the shape of the plate surface of the discharge paddle 554 is a rectangular shape. The discharge paddle 554 is attached such that one surface thereof faces the surface of the rotation shaft 551. Of the front and rear plate surfaces of the discharge paddle 554, the surface facing the surface of the rotation shaft 551 is a discharge surface 554a, and functions as a conveyance surface portion as a surface that conveys the developer in a direction intersecting the axial direction. The discharge surface 554a is provided to extend in a tangential direction of the cross-sectional circle of the rotation shaft 551.

As illustrated in FIG. 7, the discharge paddle 554 is provided between the blades of the reverse spiral blade 553 in the axial direction. Here, the direction in which the developer is conveyed by the reverse spiral blade 553 is from the front side to the back side, which is the opposite direction to the direction in which the developer is conveyed by the spiral blade 552. Therefore, the developer conveyed by the reverse spiral blade 553 adheres to the back surface of the reverse spiral blade 553. Therefore, the discharge paddle 554 is attached to a position close to the back surface of the reverse spiral blade 553, that is, on the front side of the pitch of the reverse spiral blade 553 in order to discharge more developer. More specifically, in a case where the length from the center of the discharge paddle 554 in the axial direction to the surface of the reverse spiral blade 553 on the front side in the axial direction is set as L1, and the length from the center of the discharge paddle 554 in the axial direction to the surface of the reverse spiral blade 553 on the back side in the axial direction is set as L2, the discharge paddle 554 as the first conveyance portion is arranged such that L1<L2 is satisfied and is arranged to be biased toward the side where the reverse spiral blade 553 as the second conveyance portion conveys the developer.

In addition, as described above, the discharge paddle 554 is arranged to be biased toward the front side in the axial direction, but there is a gap between the blades of the reverse spiral blade 553 and the discharge paddle 554. Due to the gap, the developer between the blades of the reverse spiral blade 553 and the discharge surface 554a of the discharge paddle 554 drops from the discharge surface 554a, and fluctuations in the amount of the developer placed on the discharge surface 554a are suppressed.

Further, the length from the center of the rotation shaft of the rotation shaft 551 to the distal end of the discharge paddle 554 is shorter than the length from the center of the rotation shaft of the rotation shaft 551 to the distal end of the reverse spiral blade 553. In other words, the distal end of the discharge paddle 554 is positioned closer to the center side of the rotation shaft than the distal end of the reverse spiral blade 553. In this manner, the discharge of the developer from the pressure adjustment port 69 is suppressed.

The discharge port 68 is provided at a position corresponding to the position where the discharge paddle 554 is provided in the axial direction. A part of the position of the discharge port 68 in the axial direction coincides with a part of the position of the discharge paddle 554 in the axial direction. In other words, the discharge port 68 is provided at a position where at least a part of the discharge port 68 in the axial direction overlaps the discharge surface 554a. The discharge port 68 is at a position corresponding to the direction in which the discharge surface 554a of the discharge paddle 554 conveys the developer. In this manner, the discharge of the developer through the discharge port 68 is urged by the discharge paddle 554.

The pressure adjustment port 69 is provided at a position corresponding to the position where the discharge paddle 554 is provided in the axial direction. A part of the position of the pressure adjustment port 69 in the axial direction coincides with a part of the position of the discharge paddle 554 in the axial direction. In other words, the pressure adjustment port 69 is provided at a position where at least a part of the pressure adjustment port 69 in the axial direction overlaps the discharge surface 554a. In this manner, the pressure fluctuations caused by the rotation of the discharge paddle 554 are suppressed by the pressure adjustment port 69.

In addition, in FIG. 8, the rotation shaft 551 rotates in a clockwise direction (direction D in FIG. 8). Then, the pressure adjustment port 69 is provided such that at least a part of the pressure adjustment port 69 in the axial direction is positioned above the discharge port 68 and is positioned on the downstream side in the rotation direction. In this manner, the pressure fluctuations caused by the developer being discharged from the discharge port 68 can be adjusted by the pressure adjustment port 69.

### Operation

Next, the operation of the developing device 33 to which the present exemplary embodiment is applied will be described.

First, the flow in which the developer accommodated in the accommodation portion 53 circulates will be described using FIG. 3. New developer replenished from the developer replenishment port 61 is conveyed from the front side to the back side in the replenishment path 54. The developer conveyed to the back side is conveyed to the agitation path 55 via the first communication path 511. Then, the developer is conveyed from the back side to the front side in the agitation path 55, and is conveyed to the supply path 56 via the second communication path 512. In this case, a part of the developer in the agitation path 55 advances to the back side of the reverse spiral blade 553, and is discharged to the outside of the accommodation portion 53 through the discharge port 68. The developer conveyed to the supply path 56 advances within the supply path 56 from the front side to the back side. In this case, a part of the developer is pumped up by the pumping roll 52 (refer to FIG. 2) provided above the supply path 56, and is supplied to the developing roll 51. The developer that has not been pumped up by the pumping roll 52 is conveyed to the back side of the supply path 56. The developer conveyed to the back side of the supply path 56 is conveyed to the agitation path 55 and circulates.

Next, the flow in which the developer is discharged from the discharge port 68 will be described using FIGS. 7 and 8.

As illustrated in FIG. 7, a part of the developer conveyed from the back side to the front side in the axial direction by the spiral blade 552 advances to the back of the reverse spiral blade 553, and is conveyed from the front side to the back side by the reverse spiral blade 553. A part of the developer conveyed to the position where the discharge paddle 554 is provided is discharged through the discharge port 68 by the discharge surface 554a of the discharge paddle 554. In FIG. 8, the flow in which the developer is discharged from the discharge port 68 is indicated by an arrow G5.

Next, the flow in which air is discharged from the pressure adjustment port 69 will be described using FIG. 8.

The discharge paddle 554 has the discharge surface 554a facing in a direction intersecting the rotation shaft 551 in order to convey the developer to the discharge port 68, and not only the developer but also the air within the agitation path 55 is moved by the discharge surface 554a in a direction intersecting the rotation shaft 551. Therefore, the discharge paddle 554 can become a cause of the pressure fluctuations of the air within the agitation path 55. Here, the pressure adjustment port 69 is provided above the discharge port 68 in a direction in which the discharge surface 554a faces, and a part of the air moved by the discharge surface 554a flows to the pressure adjustment port 69. The air that has flowed to the pressure adjustment port 69 flows out to the discharge route 58 outside the agitation path 55 through the through-hole formed by the connection portion 63 and the closing portion 65. In FIG. 8, the flow of the air flowing out from the pressure adjustment port 69 is indicated by an arrow K.

Since the air flows from the pressure adjustment port 69, the pressure fluctuations caused by the discharge paddle 554, which can be a cause of pressure fluctuations, are suppressed. That is, the pressure fluctuations around the discharge port 68 provided at a position corresponding to the discharge paddle 554 are suppressed.

As described in detail above, in the present exemplary embodiment, the discharge paddle 554 conveys the developer to the discharge port 68 to suppress fluctuations in the discharge amount due to the fluidity of the developer, and the pressure adjustment port 69 is provided to suppress fluctuations in the discharge amount due to the pressure fluctuations caused by the discharge paddle 554.

### Supplementary Note

(((1)))

A developing apparatus comprising:
a developer holder that holds a developer;
an accommodation portion that accommodates the developer to be supplied to the developer holder;
a rotation shaft rotatably provided inside the accommodation portion;
a first conveyance portion that is provided on the rotation shaft and conveys the developer in a direction intersecting an axial direction of the rotation shaft;
a second conveyance portion that is provided on the rotation shaft and conveys the developer in the axial direction;
a discharge port that is provided in the accommodation portion and through which a part of the developer is discharged to an outside at a position corresponding to a position where the first conveyance portion is provided in the axial direction; and
a pressure adjustment port that is provided in the accommodation portion and through which a pressure of the accommodation portion is adjusted at a position in a rotation direction of the first conveyance portion with respect to the discharge port, the position corresponding to a position where the first conveyance portion is provided in the axial direction.

(((2)))

The developing apparatus according to (((1))),
wherein the first conveyance portion includes a conveyance surface portion as a surface that conveys the developer in the intersecting direction along with rotation of the rotation shaft,
the discharge port is provided at a position where at least a part of the discharge port in the axial direction overlaps the conveyance surface portion, and
the pressure adjustment port is provided at a position where at least a part of the pressure adjustment port in the axial direction overlaps the conveyance surface portion.

(((3)))

The developing apparatus according to (((1))),
wherein at least parts of the discharge port and the pressure adjustment port in the axial direction overlap each other in the rotation direction of the first conveyance portion.

(((4)))

The developing apparatus according to any one of (((1))) to (((3))),
wherein the second conveyance portion includes an agitation conveyance portion that conveys the developer in one direction while agitating the developer, and a turning-back portion that is provided at an end portion of the rotation shaft in the axial direction and conveys the developer, which has been conveyed in the one direction by the agitation conveyance portion, in the other direction opposite to the one direction, and
the first conveyance portion is provided at a position where the turning-back portion is arranged in the axial direction.

(((5)))

The developing apparatus according to any one of (((1))) to (((3))),
wherein the second conveyance portion is blades provided in a spiral shape on the rotation shaft, and
the first conveyance portion is provided between the blades in the spiral shape.

(((6)))

The developing apparatus according to (((5))),
wherein the first conveyance portion is arranged between the blades to be biased to a surface side where the blades convey the developer.

(((7)))

The developing apparatus according to (((6))),
wherein a gap is provided between the blades and the first conveyance portion.

(((8)))

The developing apparatus according to any one of (((5))) to (((7))),
wherein a distal end of the first conveyance portion is positioned closer to a center side of the rotation shaft than a distal end of a blade.

(((9)))

The developing apparatus according to (((1))),
wherein an opening of the discharge port and an opening of the pressure adjustment port are formed by a common opening as one opening provided in the accommodation portion and a closing portion closing a part of the common opening.

(((10)))

The developing apparatus according to (((9))),
wherein the closing portion allows the discharge port and the pressure adjustment port to have different shapes and/or positions depending on characteristics of the developer accommodated in the accommodation portion.

(((11)))

The developing apparatus according to claim (((9))),
wherein the closing portion has a slope that moves the developer, which has entered the opening of the pressure adjustment port, toward the accommodation portion.

(((12)))

An image forming apparatus comprising:
the developing apparatus according to any one of (((1))) to (((11))),
wherein an electrostatic latent image formed by a photoreceptor is developed with the developer of which charges are stabilized by the developing apparatus to form an image on a recording material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing apparatus comprising:
a developer holder that holds a developer;
an accommodation portion that accommodates the developer to be supplied to the developer holder;
a rotation shaft rotatably provided inside the accommodation portion;
a first conveyance portion that is provided on the rotation shaft and conveys the developer in a direction intersecting an axial direction of the rotation shaft;
a second conveyance portion that is provided on the rotation shaft and conveys the developer in the axial direction;
a discharge port that is provided in the accommodation portion and through which a part of the developer is discharged to an outside at a position corresponding to a position where the first conveyance portion is provided in the axial direction; and
a pressure adjustment port that is provided in the accommodation portion and through which a pressure of the accommodation portion is adjusted at a position in a rotation direction of the first conveyance portion with respect to the discharge port, the position corresponding to a position where the first conveyance portion is provided in the axial direction.

2. The developing apparatus according to claim 1,
wherein the first conveyance portion includes a conveyance surface portion as a surface that conveys the developer in the intersecting direction along with rotation of the rotation shaft,
the discharge port is provided at a position where at least a part of the discharge port in the axial direction overlaps the conveyance surface portion, and
the pressure adjustment port is provided at a position where at least a part of the pressure adjustment port in the axial direction overlaps the conveyance surface portion.

3. The developing apparatus according to claim 1,
wherein at least parts of the discharge port and the pressure adjustment port in the axial direction overlap each other in the rotation direction of the first conveyance portion.

4. The developing apparatus according to claim 1,
wherein the second conveyance portion includes an agitation conveyance portion that conveys the developer in one direction while agitating the developer, and a turning-back portion that is provided at an end portion of the rotation shaft in the axial direction and conveys the developer, which has been conveyed in the one direction by the agitation conveyance portion, in the other direction opposite to the one direction, and
the first conveyance portion is provided at a position where the turning-back portion is arranged in the axial direction.

5. The developing apparatus according to claim 1,
wherein the second conveyance portion is blades provided in a spiral shape on the rotation shaft, and
the first conveyance portion is provided between the blades in the spiral shape.

6. The developing apparatus according to claim 5,
wherein the first conveyance portion is arranged between the blades to be biased to a surface side where the blades convey the developer.

7. The developing apparatus according to claim 6,
wherein a gap is provided between the blades and the first conveyance portion.

8. The developing apparatus according to claim 6,
wherein a distal end of the first conveyance portion is positioned closer to a center side of the rotation shaft than a distal end of a blade.

9. The developing apparatus according to claim 1,
wherein an opening of the discharge port and an opening of the pressure adjustment port are formed by a common opening as one opening provided in the accommodation portion and a closing portion closing a part of the common opening.

10. The developing apparatus according to claim 9,
wherein the closing portion allows the discharge port and the pressure adjustment port to have different shapes and/or positions depending on characteristics of the developer accommodated in the accommodation portion.

11. The developing apparatus according to claim 9,
wherein the closing portion has a slope that moves the developer, which has entered the opening of the pressure adjustment port, toward the accommodation portion.

12. An image forming apparatus comprising:
the developing apparatus according to claim 1,
wherein an electrostatic latent image formed by a photoreceptor is developed with the developer of which charges are stabilized by the developing apparatus to form an image on a recording material.

13. An image forming apparatus comprising:
the developing apparatus according to claim 2,
wherein an electrostatic latent image formed by a photoreceptor is developed with the developer of which charges are stabilized by the developing apparatus to form an image on a recording material.

14. An image forming apparatus comprising:
the developing apparatus according to claim 3,
wherein an electrostatic latent image formed by a photoreceptor is developed with the developer of which charges are stabilized by the developing apparatus to form an image on a recording material.

15. An image forming apparatus comprising:
the developing apparatus according to claim 4,
wherein an electrostatic latent image formed by a photoreceptor is developed with the developer of which charges are stabilized by the developing apparatus to form an image on a recording material.

16. An image forming apparatus comprising:
the developing apparatus according to claim 5,
wherein an electrostatic latent image formed by a photoreceptor is developed with the developer of which charges are stabilized by the developing apparatus to form an image on a recording material.

17. An image forming apparatus comprising:
the developing apparatus according to claim 6,
wherein an electrostatic latent image formed by a photoreceptor is developed with the developer of which charges are stabilized by the developing apparatus to form an image on a recording material.

18. An image forming apparatus comprising:
the developing apparatus according to claim 7,
wherein an electrostatic latent image formed by a photoreceptor is developed with the developer of which charges are stabilized by the developing apparatus to form an image on a recording material.

19. An image forming apparatus comprising:
the developing apparatus according to claim 8,
wherein an electrostatic latent image formed by a photoreceptor is developed with the developer of which charges are stabilized by the developing apparatus to form an image on a recording material.

20. An image forming apparatus comprising:
the developing apparatus according to claim 9,
wherein an electrostatic latent image formed by a photoreceptor is developed with the developer of which charges are stabilized by the developing apparatus to form an image on a recording material.
